(19) United States
(12) Patent Application Publication
(10) Pub. No.: US 2010/0026023 A1
(43) Pub. Date: Feb. 4, 2010

(54) Universal removable table guide

(76) Inventor: Inacio Andre Hernandez, Juiz de Fora (BR)

Correspondence Address: Andres F. Molina, 1938 Marsh Hawk Cir, Orlando, FL, 32837, US

(21) Appl. No.: 12/221,242

(22) Filed: Jul. 31, 2008

(51) Int. Cl. B65G 7/00

(52) U.S. Cl. 294/16

(57) ABSTRACT

A device composed of a handle together with a clamp system that incorporates to virtually any mobile table. Once it is firmly adapted to a mobile table, it will allow its operation by its handles, providing a good grip, improving control of the table and maneuverability. It allows transportation of standard mobile tables in an ergonomically correct posture.

The Universal Removable Table Guide consists of a “T-handle” which is made of a tube that is cut to be the length of the average person's chest width. Each end of the tube is slightly adjusted at an angle to allow natural positioning of hands. To each end of the tube, a rubber grip is added. In the middle of the tube, a perpendicular bar and/or tube is attached which is of the same length of the first tube, forming the “T-handle”

At the bottom end of the “T-handle” a clamp system is attached. The clamp system must be thoughtful of the size measurements, shape and materials of the table, whichever would be the most convenient for the desired table to which it will finally be put to use. The clamp system must allow modifications to be made, such as wider clamping surfaces to increase points of contact once table is clamped. Attached to the vertical part of the body of the clamp, a horizontal metal piece that is concave and is to support the edge of the table, regardless if rectangular and/or rounded.

This device operates by adapting its clamp system to the top of a mobile table. Its end must fit within the clamp opening and reach the horizontal metal piece made to support the table's edge. Table edge must make contact with the end of the table in at least two places to ensure stability while in motion. Once table end is all the way in, a handle a clamp system has a basic clamp system that opens its securing with a screw the securing arm to allow top end of a mobile table in the clamp until it reaches the stabilizer; then table should be secured by closing the screw satisfactorily secured between the flat end of the screw and the flat end of the frame. Once handle is attached to a mobile table with the clamp firmly securing the table, it enables the user to take control of the table by the handle of the universal removable table guide, for better maneuverability and control of the same allowing transportation in an upright position.

### CROSS-REFERENCE TO RELATED APPLICATIONS

Appl No. U.S. 60/933,519

### STATEMENT REGARDING FEDERALLY SPONSORED RESEARCH OR DEVELOPMENT

Not available.

### REFERENCE TO SEQUENCE LISTING, A TABLE, OR A COMPUTER PROGRAM LISTING COMPACT DISC APPENDIX

Not available.

### BACKGROUND OF THE INVENTION

The hotel industry offer several amenities and conveniences for their guests, such as room services in which they could order a full meal delivered directly to their rooms. For this service, room service tables equipped with wheels to allow their transportation across the entire hotel. These service tables (which are used in several other tasks) are designed for the convenience of the guest at a height below the average person's waist level. This means transportation carried out by employees is impossible in a natural posture, they are forced to be bent over pushing the edge of the table. This position alone puts a lot of strain in their back muscles as well as back bones. Accumulated hours transporting these tables will develop pain caused by vertebrae falling out of place, which will require surgery. While pushing these room service tables, because of the unnatural way of transporting them makes their transportation clumsy task. Room service employees are unable to maneuver properly because the position of their hands on the table does not give them a grip, they are only able to push and barely pull. Just to look forward, they must force their necks to look up. Besides all the pain through accumulated hours pushing these tables especially on their backs and necks, they also end up with their arms and legs with muscle strains. The entire body is compromised accumulatively every time these tables are used. Health of these employees is being deteriorated rapidly, raising insurance claims and in some cases requiring complicated back surgeries after developing persistent back pains.

Alternative solutions are to design, and manufacture height adjustable tables which make the table heavier, also reducing space that is currently being occupied by the heater and all the miscellaneous items that come with the meal (bottles, cups, etc).

Another alternative, currently being developed by Sico Incorporated is their “Table Guide” which operates similarly to the “Universal Removable Table Guide” with the exception that is not universal to all standard room service tables and is not removable. Their solution requires for their device to be permanently attached to those tables that allow their installation. Installation requires drilling holes to each and every table translating to installation expenses and putting several tables at a time out of service.

### BRIEF SUMMARY OF THE INVENTION

A universal room service table incorporates a “T Handle” fixed to a clamp system. Once firmly secured to a mobile table with clamp, it allows operation of the table by its handles, providing improved grip and maneuverability enabling transportation of the same in an upright position.

With the Universal Removable Table Guide, employees of room services do not need to transport tables bent over causing body aches and muscle strain, it allows transportation in an ergonomically correct posture as natural as walking in an upright position.

Existing inventions require permanent-non reversible installation to each and every table intended for use for room services and in general for mobile tables with heights below waist level, translating in installation costs and tables being temporarily out of service.

### BRIEF DESCRIPTION OF THE SEVERAL VIEWS OF THE DRAWING

FIG. 1—Top View: shows handles, upper part of screw adjuster and the bars that attached to the table to provide stability. Notice slight curved angle allows oval and rounded tables to be easily adapted, as well as rectangular and squared tables.

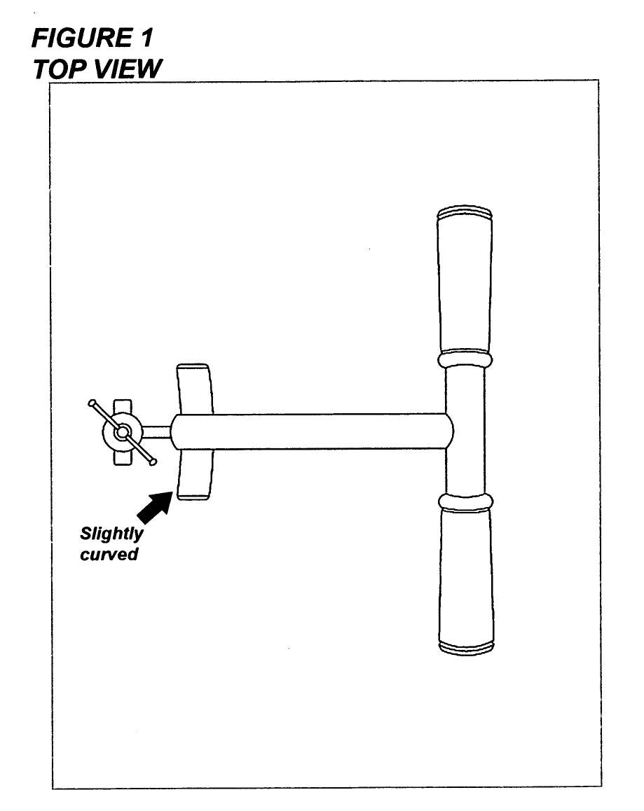

FIG. 2—Front View: shows handles, length of tool, screw of clamp, and stabilizers

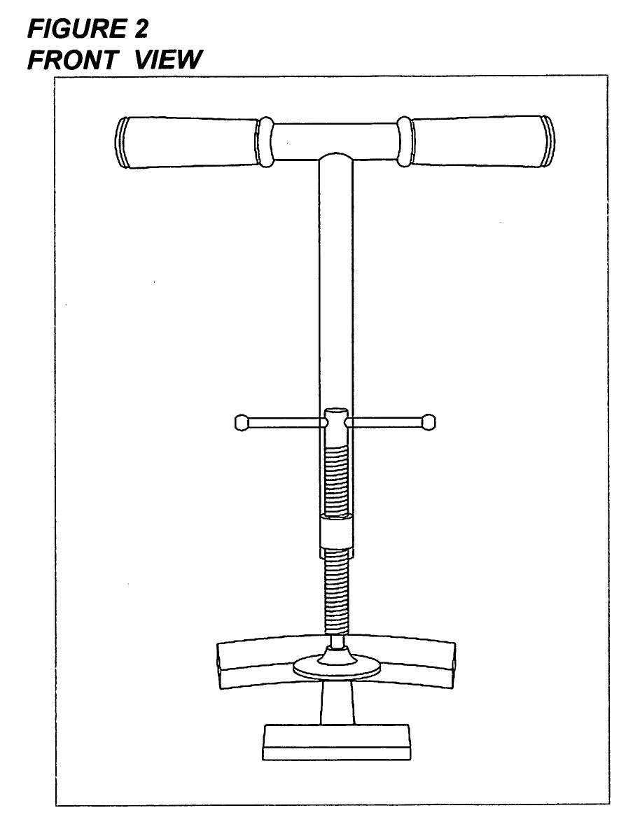

FIG. 3—Side View: shows angle at which “T Handle” is attached to clamp, side view of clamp and stabilizers

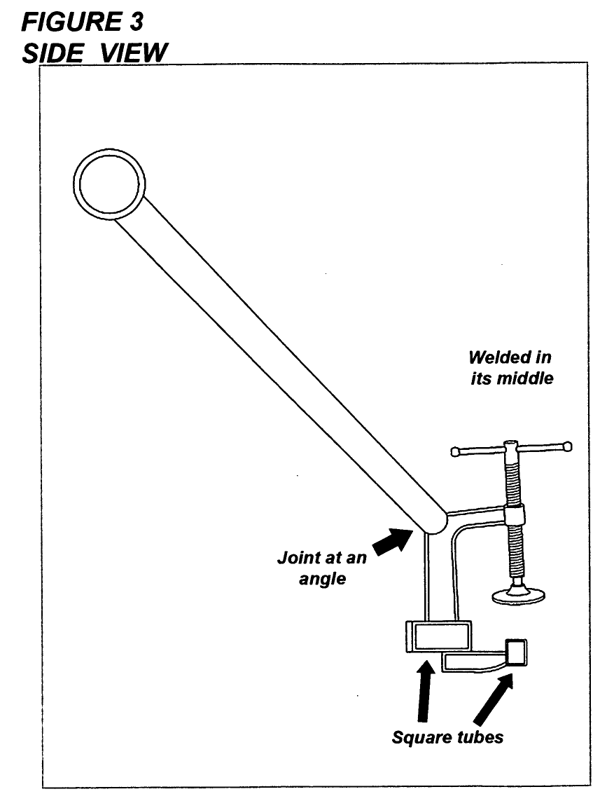

FIG. 4—Perspective View: to shows tool at an angle

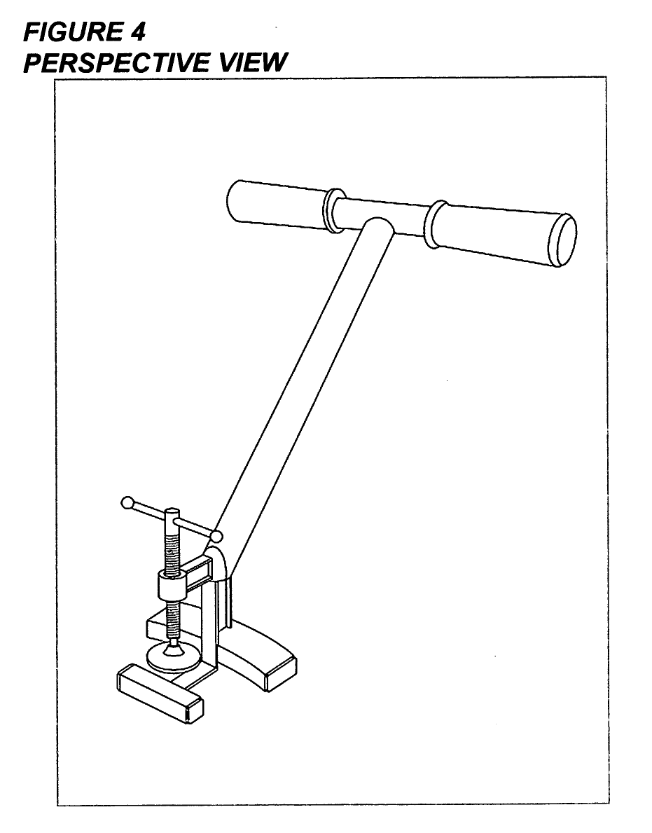

### DETAILED DESCRIPTION OF THE INVENTION

The Universal Removable Table Guide consists of a “T-handle” which is made of metallic tube that is cut to be the length of the average person's chest width. Each end of the tube is slightly adjusted at an angle to allow natural positioning of hands. To each end of the tube, a rubber grip is added. In the middle of the tube, a perpendicular bar and/or tube is attached which is of the same length of the first tube, forming the “T-handle.”

The “T-handle” end is welded together with a “C Clamp” (with its screw facing upward) at its upper corner at a 45 degree angle. The metal stick to operate the “C-clamp” located in the upper part of the screw of the clamp, is welded by its middle to the screw. The bottom end part of the screw ends in the clamping surface has been increased in its diameter by welding a circular metal piece. At the flat clamping edge of the C-clamp, a square-tube has been welded to increase the original flat clamping surface of the C-clamp. Opposite from this and leveled at the top of this square tube, the base of a square tube that has been given a slight concave curvature. This piece is welded perpendicularly to the vertical body of the “C-clamp” with its concave curvature facing outwards. All the edges are rounded and hollow square tubes are closed with fitting plastic caps.

This device operates by adapting its clamp system to the top of a mobile table. Its end must fit within the clamp opening and reach the horizontal bar that makes contact with the end of the table in at least two places to ensure stability while in motion. Once table end is all the way in, a handle a clamp system has a basic clamp system that opens its securing with a screw the securing arm to allow top end of a mobile table in the clamp until it reaches the stabilizer; then table should be secured by closing the screw satisfactorily secured between the flat end of the screw and the flat end of the frame. Once handle is attached to a mobile table with the clamp firmly securing the table, it enables the user to take control of the table by the handle of the universal removable table guide, for better maneuverability and control of the same allowing transportation in an upright position.

1. Is a handle attached and/or joint to a clamp system
According to claim one, is a “T Handle” that is attached to a “C Clamp” at an angle.
According to claim one, is a “C Clamp” modified with wider clamping surfaces and a horizontal bar designed to support the edge of the table which could be square, oval or circular.

2. Is a removable table handle and/or guide that can be temporarily attached and/or fixed to a table, then removed after use.
According to claim two a device that once it is attached to a mobile table, it improves grip, control and maneuverability of the table, enabling its transportation in an up-right posture which is ergonomically correct.

3. Is a moving table “Transporter AID Device” that allows ergonomically correct transportation of mobile tables, with a correct posture of hands.
According to claim three, is a device that allows improved control over mobile tables during transportation.
